(19) United States
(12) Patent Application Publication
(10) Pub. No.: US 2011/0319086 A1
(43) Pub. Date: Dec. 29, 2011

(54) BASE-STATION DEVICE AND HANDOVER METHOD

(75) Inventor: Masato KATORI, Kawasaki (JP)

(73) Assignee: FUJITSU LIMITED, Kawasaki-shi (JP)

(21) Appl. No.: 13/108,309

(22) Filed: May 16, 2011

(30) Foreign Application Priority Data
Jun. 24, 2010 (JP) 2010-143648

(51) Int. Cl. H04W 36/32

(52) U.S. Cl. 455/440

(57) ABSTRACT

A base-station device that forms a first cell in a wireless communication system in which a plurality of second cells are included in the first cell, includes: a reception unit configured to receive control information including information used to specify the location of a mobile terminal from the mobile terminal located in the first cell; a location information storage unit configured to store location information indicating the location of each of the plural second cells; a selection unit configured to select, based on a result obtained by comparing the location of the mobile terminal with the location information, a neighboring cell that can be a destination to which the mobile terminal is handed over from the first cell, from among the plural second cells; and a transmission unit configured to transmit to the mobile terminal a neighboring cell notification message giving notice of the selected neighboring cell.

### CROSS-REFERENCE TO RELATED APPLICATION

This application is based upon and claims the benefit of priority of the prior Japanese Patent Application No. 2010-143648, filed on Jun. 24, 2010, the entire contents of which are incorporated herein by reference.

### FIELD

The present invention relates to a base-station device used for wireless communication and a handover method for a mobile terminal.

### BACKGROUND

In recent years, in some cases, in order to resolve a radio wave dead zone, small base stations such as a femtocell base station and the like have been installed in indoor locations such as an underground passage, stores, standard homes, and the like, for example. In addition, in some cases, in order to deal with an increase in the number of users located in a macrocell in an urban area or the like and an increase in communication volume per one user, a plurality of femtocell base stations have been installed in a macrocell. Furthermore, in some cases, since the femtocell is narrow compared with the macrocell or the like, the femtocell has been used for specifying the location information of a user. In this way, the femtocells have been used for various intended purposes, and the femtocells are expected to be more prevalent.

In addition, since the femtocell has a small communication area, and the number of users to be accommodated by the femtocell is small, it may be considered that a situation in which no user exists in the communication area occurs more frequently than the macrocell. Therefore, during a time period when no user exists in the communication area, there has been an attempt to reduce the power consumption of a base station included in the femtocell. For example, there has been a system, in which a femtocell base station is installed that generates a control signal when a user exists in the communication area, and a base station starts outputting a wireless signal, the base station being included in a femtocell adjacent to the femtocell including the base station that generates the control signal. An example of the related art is Japanese Unexamined Patent Application Publication No. 2009-159355.

### SUMMARY

According to an aspect of an embodiment, a base-station device that forms a first cell in a wireless communication system in which a plurality of second cells are included in the first cell, the base-station device includes: a reception unit configured to receive control information including information used to specify the location of a mobile terminal from the mobile terminal located in the first cell; a location information storage unit configured to store location information indicating the location of each of the plural second cells; a selection unit configured to select, based on a result obtained by comparing the location of the mobile terminal with the location information, a neighboring cell that can be a destination to which the mobile terminal is handed over from the first cell, from among the plural second cells; and a transmission unit configured to transmit to the mobile terminal a neighboring cell notification message giving notice of the selected neighboring cell.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system according to an embodiment;

FIG. 2 is a diagram illustrating an example of an arrangement of femtocells;

FIG. 3 is a diagram illustrating examples of configurations of a macrocell base station and a femtocell base station;

FIG. 4 is a diagram illustrating an example of a cell location database;

FIG. 5 is a sequence diagram explaining an example of an operation performed when a mobile terminal is handed over from a macrocell to a femtocell;

FIG. 6 is a diagram illustrating an example of a neighboring cell information request message;

FIG. 7 is a diagram illustrating an example of a neighboring cell table;

FIG. 8 is a diagram illustrating an example of a neighboring cell information notification message;

FIG. 9 is a sequence diagram explaining an example of an operation performed when a femtocell base station is requested to transmit an annunciation signal;

FIG. 10 is a diagram illustrating an example of a resume cancellation request message;

FIG. 11 is a diagram illustrating an example of a resume cancellation notification message;

FIG. 12 is a sequence diagram explaining an example of an operation performed in a femtocell base station when a resume cancellation request message is received;

FIG. 13 is a diagram illustrating an example of a resume setting notification message;

FIG. 14 is a diagram illustrating an example of an arrangement of cells when a third embodiment is applied;

FIG. 15 is a diagram illustrating an example of a system available for the third embodiment;

FIG. 16 is a diagram illustrating an example of a cell location database used in the third embodiment;

FIG. 17 is a sequence diagram explaining an example of an operation performed in the third embodiment;

FIGS. 18A to 18C are diagrams explaining an example of a generation method used for a neighboring cell list;

FIG. 19 is a diagram illustrating an example of a hardware configuration of a macrocell base station;

FIG. 20 is a diagram illustrating an example of a hardware configuration of a femtocell base station;

FIG. 21 is a diagram illustrating an example of a system in which a plurality of macrocell base stations exchange information of a femtocell in a macrocell with one another; and

FIG. 22 illustrates an example of a system in which an overhanging transmitter-receiver is used.

### DESCRIPTION OF EMBODIMENTS

Hereinafter, the present embodiment will be described in detail with reference to figures. In the following embodiment, a case will be described in which a plurality of femtocell base stations are installed in one macrocell. In addition, the femtocell base station is not limited to a case in which the femtocell base station is installed in the macrocell, and it may be assumed that the femtocell base station is installed in a microcell or a picocell, for example. In addition, it is assumed that the mobile terminal communicating with the macrocell base station and the femtocell base station can calculate location information using an arbitrary method such as a Global Positioning System (GPS), Assisted GPS, or the like.

The cell radius of a macrocell is larger than the cell radius of a femtocell. Therefore, if femtocells are prevalent, the number of femtocells located around a macrocell is supposed to increase. In addition, in some cases, a plurality of femtocell base stations are installed in one macrocell. When being handed over, a mobile terminal located in a macrocell is notified of information of a femtocell located around the macrocell or information of another macrocell and information of a femtocell in the macrocell in which the mobile terminal is located. However, since the cell radius of the macrocell is longer than the reach of a signal transmitted from the mobile terminal, cells receiving notifications may include a cell to which it is difficult for the mobile terminal to be handed over. In this case, since the mobile terminal acquires information unavailable for handover, there is a problem that a useless load rests on the mobile terminal.

In addition, while, in the column of the background art, a case has been described in which the femtocell base station is installed in the macrocell, there is a possibility that the femtocell base station is installed in an arbitrary cell such as a picocell, a microcell, or the like, which is smaller than the macrocell and larger than the femtocell. Also in such a case, when handover is performed between a mobile terminal and a base station forming a femtocell, it is preferable that the information of a cell to which it is difficult for the mobile terminal to be handed over is not transmitted to the mobile terminal.

An embodiment provides a base-station device that forms a first cell in a wireless communication system in which a plurality of second cells are included in the first cell. The base-station device includes a reception unit, a location information storage unit, a selection unit, and a transmission unit. The reception unit receives control information including information used for specifying the location of a mobile terminal from the mobile terminal located in the first cell. The location information storage unit stores location information indicating the location of each of the plural second cells. The selection unit selects, on the basis of a result obtained by comparing the location of the mobile terminal with the location information, a neighboring cell that can be a destination to which the mobile terminal is handed over from the first cell, from among the plural second cells. The transmission unit transmits to the mobile terminal a neighboring cell notification message giving notice of the neighboring cell.

The processing load of a mobile terminal handed over from a cell larger than a femtocell to the femtocell is reduced.

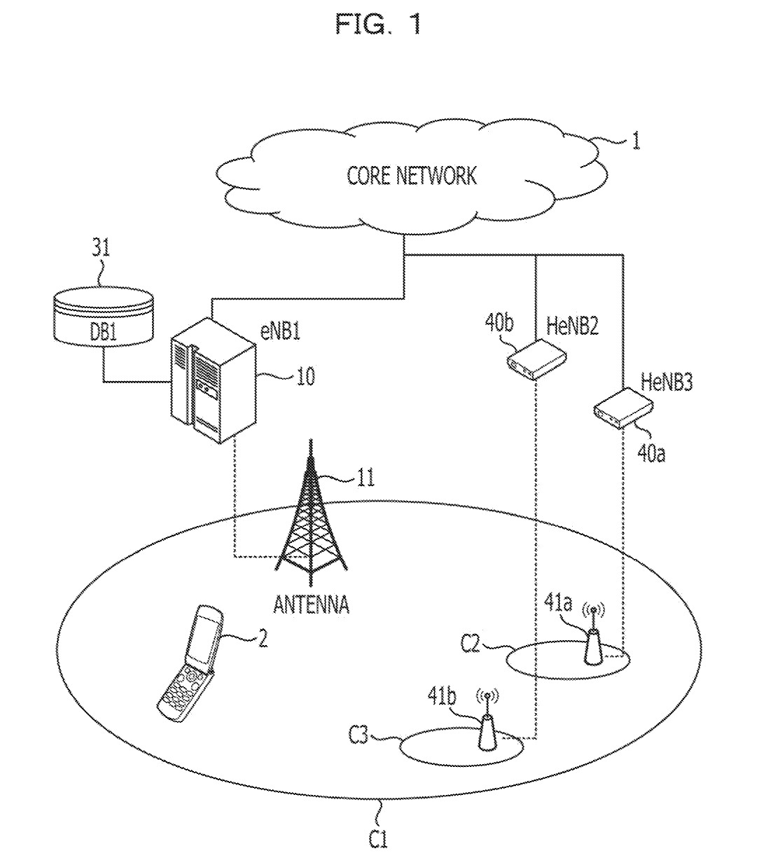

FIG. 1 is a diagram illustrating an example of a system according to the embodiment. A macrocell base station 10 forms a macrocell (cell C1). The macrocell base station 10 includes an antenna 11, a cell location database 31, and the like, and communicates with a mobile terminal 2 located in the macrocell through the antenna 11. In addition, for example, through an inter-station line, the macrocell base station 10 can communicate with a femtocell base station 40 (40a or 40b) forming a femtocell in the macrocell. Furthermore, the macrocell base station 10 can also communicate with the femtocell base station 40 through a core network 1. In addition, FIG. 1 is an example of the system, and, for example, the macrocell base station 10 may also be connected to another macrocell base station 10a (not illustrated) through the core network 1. In this case, the macrocell base station 10 can communicate with the macrocell base station 10a through the core network 1.

The femtocell base station 40 includes an antenna 41 (41a or 41b), and forms a femtocell (cell C2 or C3 in FIG. 1) in the macrocell. The macrocell base station 10 that has established a connection with the mobile terminal 2 acquires information used for specifying the location of the mobile terminal 2 from the mobile terminal 2. After that, the macrocell base station 10 selects a neighboring cell that can be a destination to which the mobile terminal 2 is handed over, by referring to data such as a database included in the cell location database 31, or the like. In the following description, in some cases, a cell that can be a handover destination when the mobile terminal 2 is handed over from the macrocell to which the mobile terminal 2 is connected to another cell is described as a “neighboring cell”.

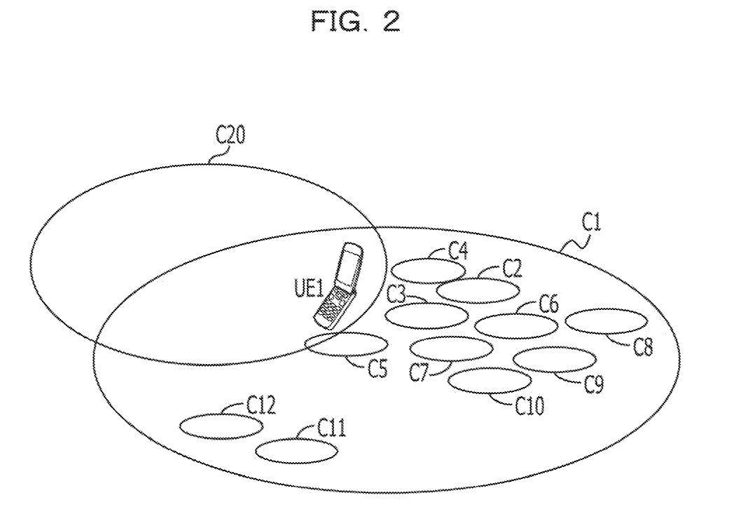

FIG. 2 is a diagram illustrating an example of the arrangement of femtocells. An example of a neighboring cell will be described with reference to FIG. 2. In FIG. 2, it is assumed that a cell C1 and a cell C20 are macrocells and cells C2 to C12 are femtocells. In addition, it is assumed that the mobile terminal 2 is connected to a base station forming the cell C1. In this case, neighboring cells located around the mobile terminal 2 (terminal UE1) to which an identifier UE1 is attached are femtocells that can be the handover destination of the terminal UE1 from among femtocells formed in the cell C1. Here, it is assumed that the neighboring cells of the terminal UE1 are the cells C2 to C5.

The macrocell base station 10 forming the cell C1 notifies the terminal UE1 that the neighboring cells are the cells C2 to C5. Here, for example, the macrocell base station 10 can notify the terminal UE1 of identifiers used for individually identifying the cells C2 to C5. The terminal UE1 measures the intensity of electric power received from each of the cells C2 to C5, and establishes a connection with the femtocell base station 40 the intensity of the reception power of which is strongest. In this way, the terminal UE1 does not receive from the macrocell base station 10 information relating to a femtocell to which it is difficult for the terminal UE1 to be handed over. Namely, according to the present embodiment, since the macrocell base station 10 restricts information to be transmitted at the time of handover to information relating to the neighboring cells, the load of the mobile terminal 2 is reduced.

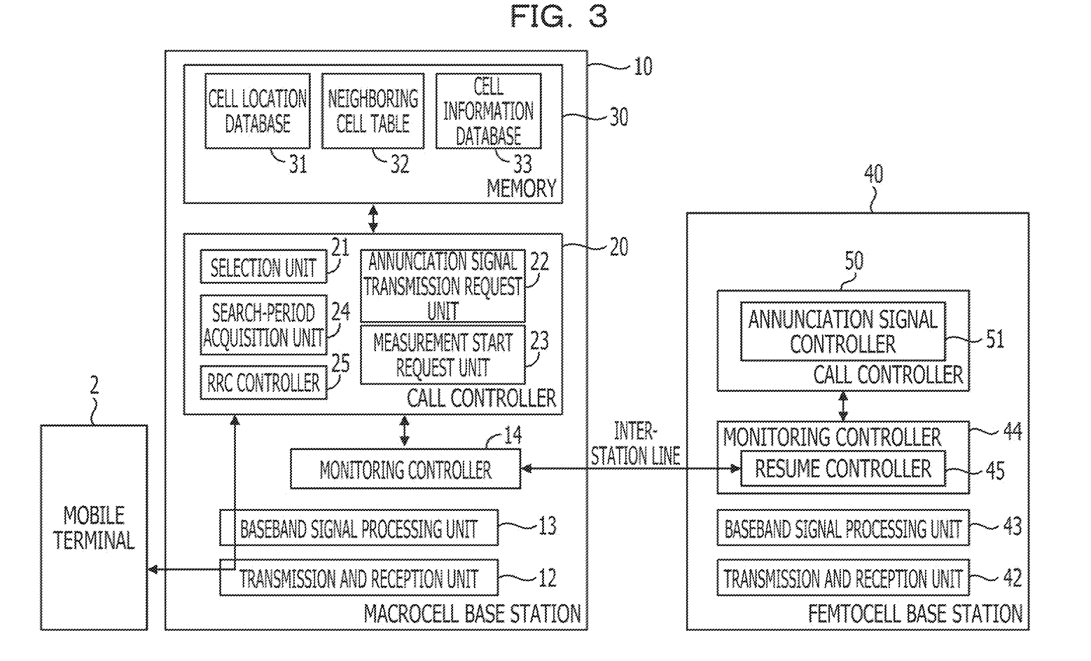

FIG. 3 is a diagram illustrating examples of the configurations of the macrocell base station 10 and the femtocell base station 40. The macrocell base station 10 includes an antenna 11 (not illustrated), a transmission and reception unit 12, a baseband signal processing unit 13, a monitoring controller 14, a call controller 20, and a memory 30. The call controller 20 includes a selection unit 21, an annunciation signal transmission request unit 22, a measurement start request unit 23, a search-period acquisition unit 24, and a Radio Resource Control (RRC) controller 25. A CPU (Central Processing Unit), DSP (Digital Signal Processor) or the like provides functions executed by the call controller 20. A CPU (Central Processing Unit), DSP (Digital Signal Processor) or the like also provides functions executed by the monitoring controller 14.

Using the antenna 11 and the transmission and reception unit 12, the macrocell base station 10 communicates with the mobile terminal 2. Using a carrier wave, the transmission and reception unit 12 transmits data generated in the baseband signal processing unit 13 to the mobile terminal 2. In addition, the transmission and reception unit 12 extracts a baseband signal by removing the carrier wave from a signal received from the mobile terminal 2, and outputs the baseband signal to the baseband signal processing unit 13.

Using the inter-station line that connects the macrocell base station 10 and the femtocell base station 40 to each other, the monitoring controller 14 communicates with the femtocell base station 40. For example, the monitoring controller 14 can request the femtocell base station 40 to transmit an annunciation signal or to cancel a resume state. In addition, the monitoring controller 14 receives from the femtocell base station 40 a notification (resume setting notification message) of putting the femtocell base station 40 into a resume state, a notification (resume cancellation notification message) of cancelling the resume state, and the like. Information elements included in the resume setting notification message and the like and an operation in which these messages are used will be described later.

Here, it is assumed that, in the resume state, the base station halts the transmission of the annunciation signal. In addition, it is assumed that, when being put into the resume state, the femtocell base station 40 reduces electric energy consumed by the femtocell base station 40, by halting power supply to portions other than the monitoring controller 44, for example. When the resume state is being cancelled, the femtocell base station 40 can communicate with the mobile terminal 2. Using a notification received from the femtocell base station 40, a notification transmitted by the monitoring controller 14, or the like, the monitoring controller 14 monitors whether or not an annunciation signal is transmitted from the femtocell base station 40.

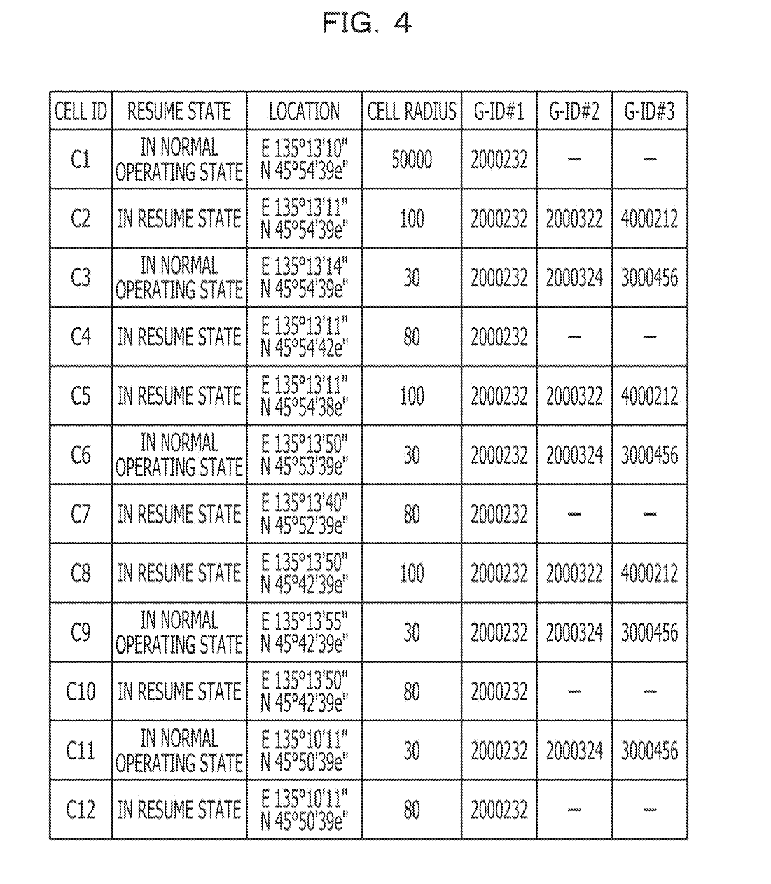

The memory 30 includes a cell location database 31, a neighboring cell table 32, and a cell information database 33. FIG. 4 is a diagram illustrating an example of the cell location database 31. For example, the cell location database 31 includes a cell ID, the location of a base station forming a cell, a cell radius, and the like. Namely, the cell location database 31 is an example of the location information storage unit.

While the state of a base station and the identifier of a group into which the base station is classified are included in the cell location database 31 illustrated in FIG. 4, these pieces of information are optional, and may be arbitrarily omitted. The state of the base station indicates whether the base station is put into the resume state. When the state of the base station is included in the cell location database 31, the monitoring controller 14 records in the cell location database 31 information indicating whether the femtocell base station 40 has been put into the resume state, with respect to each femtocell base station 40. For example, when the monitoring controller 14 receives the resume setting notification message from the femtocell base station 40, the monitoring controller 14 registers in the cell location database 31 information indicating that the base station is normally operated. In some cases, the cell location database 31 includes information relating to the macrocell base station 10 in addition to information relating to the femtocell base station 40. In addition, FIG. 4 is an example of the cell location database 31, and an information element included in the cell location database 31 may be changed in accordance with implementation. In addition, the location information storage unit can store a cell ID, the location of a base station forming a cell, a cell radius, and the like in an arbitrary form. For example, the location information storage unit can also store data in a form such as a table, a list, or the like other than a database.

The neighboring cell table 32 records the identifier of a cell located around the location of the mobile terminal 2 and a distance from the mobile terminal 2 with associating the identifier and the distance with the identifier of the mobile terminal 2. As described later, the neighboring cell table 32 is generated from the cell location database 31 by the selection unit 21.

The cell information database 33 records information relating to a femtocell formed in a macrocell. For example, information, which relates to a frequency used for communication between a base station forming a femtocell and the mobile terminal 2, and a parameter such as the priority of selection of a cell or the like are recorded in the cell information database 33 with the information and the parameter being associated with the identifier of the femtocell. The macrocell base station 10 extracts from the cell information database 33 information relating to each of neighboring cells, and notifies the mobile terminal 2 of the information along with information used for specifying the neighboring cell.

The call controller 20 controls a connection between the mobile terminal 2 and the macrocell base station 10. The RRC controller 25 acquires information used for specifying the location of the mobile terminal 2, from data received from the mobile terminal 2. Furthermore, using the neighboring cell table 32 or the cell information database 33, the RRC controller 25 notifies the mobile terminal 2 of information relating to the neighboring cell of the mobile terminal 2. In addition, the RRC controller 25 also performs call control for the mobile terminal 2 that has established a connection with the macrocell base station 10, the setting of a transmission path to the mobile terminal 2, and the like. The RRC controller 25 can perform these processing operations, using an arbitrary protocol such as an RRC protocol or the like, for example.

The selection unit 21 compares the location of the mobile terminal 2 with the location of the base station recorded in the cell location database 31, and selects a neighboring cell that can be the handover destination of the mobile terminal 2. The selection unit 21 records in the neighboring cell table 32 information relating to the neighboring cell selected from the cell location database 31. An example of the neighboring cell table 32 and the usage method thereof will be described later.

Through the monitoring controller 14, the annunciation signal transmission request unit 22 requests the femtocell base station 40, which forms the neighboring cell, to transmit an annunciation signal. Through the transmission and reception unit 12, the measurement start request unit 23 transmits a measurement start request message to the mobile terminal 2. When receiving the measurement start request message, the mobile terminal 2 measures the intensity of reception power from each of neighboring cells.

The search-period acquisition unit 24 acquires a base-station search period in which the mobile terminal 2 searches for a base station to be a handover destination, from data the RRC controller 25 acquires. The search-period acquisition unit 24 notifies the annunciation signal transmission request unit 22 of the acquired base-station search period. The annunciation signal transmission request unit 22 can generate a request message that requests a neighboring cell to transmit an annunciation signal for a time period longer than the base-station search period.

The femtocell base station 40 includes an antenna 41 (not illustrated), a transmission and reception unit 42, a baseband signal processing unit 43, a monitoring controller 44, a resume controller 45, a call controller 50, and an annunciation signal controller 51. The femtocell base station 40 communicates with the mobile terminal 2 located in the femtocell, through the antenna 41. The operation of the transmission and reception unit 42 is substantially the same as that of the transmission and reception unit 12. In addition, the operation of the baseband signal processing unit 43 is substantially the same as that of the baseband signal processing unit 13. A CPU (Central Processing Unit), DSP (Digital Signal Processor) or the like provides functions executed by the monitoring controller 44. A CPU (Central Processing Unit), DSP (Digital Signal Processor) or the like also provides functions executed by the call controller 50.

Using the inter-station line that connects the macrocell base station 10 and the femtocell base station 40 to each other, the monitoring controller 44 communicates with the monitoring controller 14 with transmitting a resume setting notification message, a resume cancellation notification message, or the like.

The resume controller 45 adjusts the electric power consumption of the femtocell base station 40, in accordance with the notification the monitoring controller 44 has received. For example, when the monitoring controller 44 receives from the monitoring controller 14 a message that requests to transmit an annunciation signal, the resume controller 45 changes the state of the femtocell base station 40 from the resume state to a normal operating state. The resume controller 45 can also include a timer (not illustrated), and can cancel the setting of the resume state on the femtocell base station 40, only during a time period for which the timer is set. For example, the resume controller 45 sets the timer for a time period the monitoring controller 44 has given notice of, and can cancel the setting of the resume state on the femtocell base station 40 until the timer expires. In addition, the resume controller 45 monitors the state of a control channel located between the femtocell base station 40 and the mobile terminal 2. When the resume controller 45 detects that the femtocell base station 40 does not communicate with any mobile terminal 2, the resume controller 45 puts the femtocell base station 40 into the resume state.

The call controller 50 controls a connection between the mobile terminal 2 and the femtocell base station 40, and performs call control for the mobile terminal 2, the setting of a transmission path to the mobile terminal 2, and the like. When the resume state is cancelled, the annunciation signal controller 51 transmits an annunciation signal.

### First Embodiment

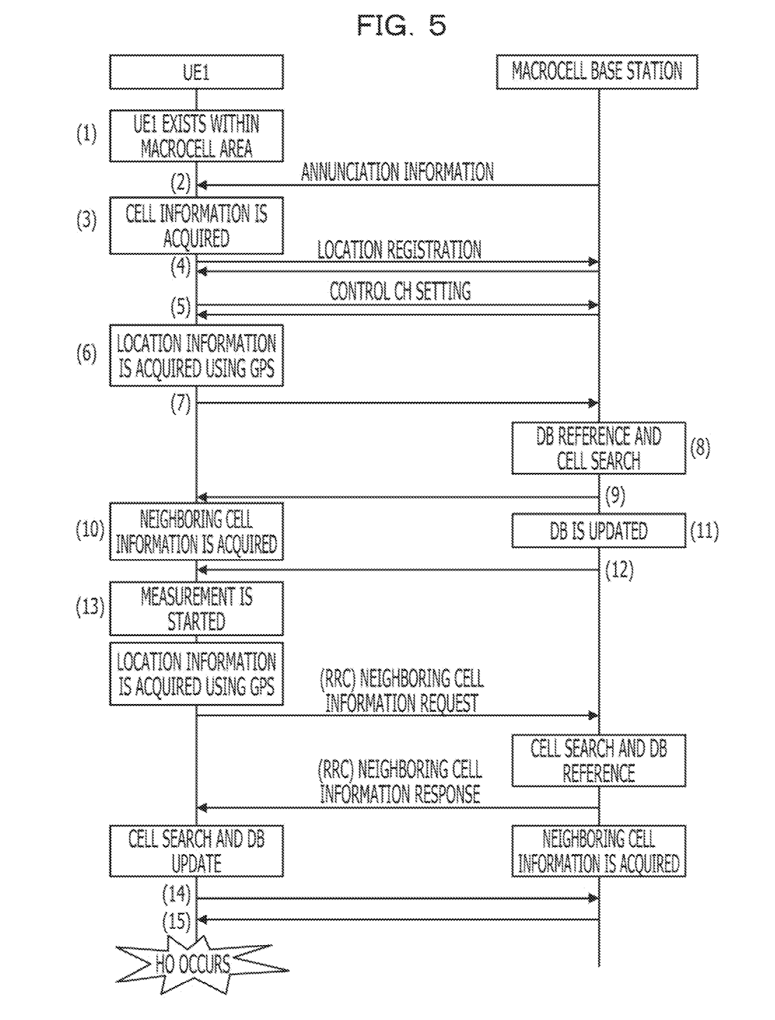

FIG. 5 is a sequence diagram explaining an example of an operation performed when the mobile terminal 2 is handed over from the macrocell to the femtocell. While an example of the operation of the macrocell base station 10 will be described in detail with reference to FIG. 5, the operations of the mobile terminal 2 and the macrocell base station 10 may be changed in accordance with implementation. For example, the following Procedure (11) is optional, and the procedure (11) may also be arbitrarily omitted.

Here, it is assumed that the identifier of the mobile terminal 2 is “UE1” and the terminal UE1 is handed over from the cell C1 to the cell C3 illustrated in FIG. 2. In addition, it is assumed that the terminal UE1 calculates location information using a GPS. In the first embodiment, it is assumed that any femtocell base station 40, which forms a cell that can be the handover destination of the terminal UE1, is not put into a resume state. As described later, the macrocell base station 10 individually obtains a neighboring cell with respect to each mobile terminal 2 the location information of which has been given notice of. Namely, a neighboring cell or the content of the neighboring cell table 32 is different depending on each mobile terminal 2. Therefore, in the following description, in some case, in order to discriminate the mobile terminal 2, to which the identifier UE1 is attached, from another mobile terminal 2 to which another identifier is attached, the mobile terminal 2 may also be described as a terminal UE1.

(1) The terminal UE1 moves to a location in which the terminal UE1 can communicate with the macrocell base station 10 forming the cell C1.

(2) The macrocell base station 10 forming the cell C1 transmits annunciation information. The terminal UE1 receives the annunciation information transmitted from the macrocell base station 10. Here, the annunciation information includes information used for specifying a femtocell located around or in the cell C1. At this time, since the macrocell base station 10 is not informed of the location of the terminal UE1, the macrocell base station 10 may transmit to the terminal UE1 information relating to a cell that is not the neighboring cell of the terminal UE1. For example, here, it is assumed that the annunciation information includes information used for specifying each of cells C2, C7, C8, C11, and C20.

(3) The terminal UE1 acquires the information of the cells, included in the annunciation information.

(4) The terminal UE1 transmits to the macrocell base station 10 information used for giving notice of the location of the terminal UE1. The macrocell base station 10 registers the location of the terminal UE1, and transmit a response message to the terminal UE1.

(5) A channel used for transmitting and receiving control data between the terminal UE1 and the macrocell base station 10 is established. When the channel used for transmitting and receiving the control data is established, a control message such as a message, which uses an RRC protocol, or the like can be transmitted and received between the macrocell base station 10 and the terminal UE1.

(6) Using the GPS, the terminal UE1 acquires location information such as the latitude and longitude of a point at which the terminal UE1 is located and the like. Here, it is assumed that the terminal UE1 is located at 45 degrees, 54 minutes, and 40 seconds north in latitude and 135 degrees, 13 minutes, and 12 seconds east in longitude.

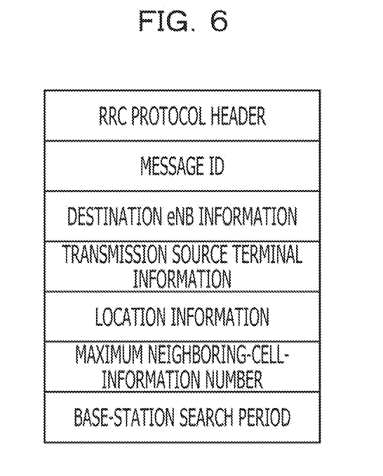

(7) The terminal UE1 transmits a neighboring cell information request message 60 to the macrocell base station 10. FIG. 6 is a diagram illustrating an example of the neighboring cell information request message 60. The neighboring cell information request message 60 illustrated in FIG. 6 includes information used for identifying a base station of a destination, the identifier of the transmission source mobile terminal 2 that is a transmission source, the location information of the mobile terminal 2, a maximum neighboring-cell-information number, and the like. The information used for identifying the base station of a destination may be arbitrary information such as the identifier of the macrocell base station 10 or the like, which is capable of uniquely specifying the macrocell base station 10 that forms the cell C1. The location information of the mobile terminal 2 is the location information obtained in Procedure (6).

The maximum neighboring-cell-information number is an upper limit value of the number of neighboring cells the information of which the mobile terminal 2 acquires. As described later, the macrocell base station 10 notifies the mobile terminal 2 of the information of base stations the number of which is less than or equal to the maximum neighboring-cell-information number. For example, even in a case in which five neighboring cells of the terminal UE1 are selected, when the maximum neighboring-cell-information number is three, the macrocell base station 10 notifies the terminal UE1 of the information of three cells from among the cells selected as neighboring cells.

The base-station search period is a period in which the mobile terminal 2 searches for a base station to be a handover destination. For example, a time corresponding to one period of the base-station search period can be set to a time elapsing from a time when the mobile terminal 2 transmits the neighboring cell information request message 60 to a time when the mobile terminal 2 transmits a subsequent neighboring cell information request message 60.

For example, the RRC protocol header is a header attached to a message that uses an RRC protocol specified with 3GPP. In addition, the message ID is an identifier used for indicating the kind of the message of the RRC protocol. The macrocell base station 10 and the mobile terminal 2 store the message ID and the kind of the control message with associating the message ID with the kind of the control message, and recognizes the kind of the control message using the message ID.

(8) Using the location information included in the neighboring cell information request message 60, the selection unit 21 searches the cell location database 31, and selects a neighboring cell that can be the handover destination of the mobile terminal 2. For example, by comparing the latitude and longitude of the location of the mobile terminal 2 with the latitude and longitude of the center location of a cell, recorded in the cell location database 31, the selection unit 21 can select, as a neighboring cell, a femtocell the locational difference of which is less than or equal to a predetermined threshold value. In addition, using a distance between the mobile terminal 2 and a cell edge in addition to the latitudes and longitudes of the location of the mobile terminal 2 and the center location of a cell, the selection unit 21 can also select a neighboring cell.

For example, when a threshold value is 2 seconds with respect to the latitude and the longitude, a cell, the center location of which is located at 45 degrees, 54 minutes, and 38 to 40 seconds north in latitude and 135 degrees, 13 minutes, and 10 to 12 seconds east in longitude, can be the neighboring cell of the terminal UE1. Since the cells C2 to C5 correspond to the locations of neighboring cells on the basis of the cell location database 31, the selection unit 21 selects the cells C2 to C5 as the neighboring cells of the terminal UE1, and generates the neighboring cell table 32.

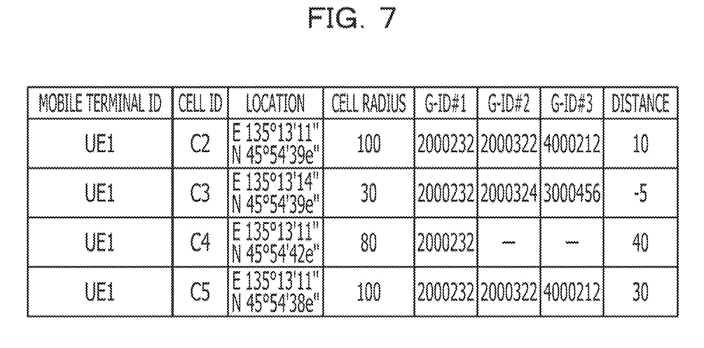

In FIG. 7, an example of the neighboring cell table 32 is illustrated. The neighboring cell table 32 illustrated in FIG. 7 includes the identifier of the mobile terminal 2 and the distance between the mobile terminal 2 and a cell edge in addition to information such as the location of a neighboring cell and the like. The distance between the mobile terminal 2 and the cell edge is a distance from the mobile terminal 2 to a cell edge located nearest the mobile terminal 2 in cell edges. The selection unit 21 calculates a distance between the mobile terminal 2 and the cell edge with respect to each of neighboring cells, using the following expression.

Distance=L−r

Here, the “L” indicates a distance between the mobile terminal 2 and a base station forming a cell whose distance to the mobile terminal 2 is to be calculated. The “r” indicates the cell radius of the cell whose distance to the mobile terminal 2 is to be calculated. Accordingly, for example, a distance between the cell C3 and the mobile terminal 2 is a value obtained by subtracting the cell radius of the cell C3 from a distance between the location of the femtocell base station 40 forming the cell C3 and the location of the mobile terminal 2. In addition, the distance between the mobile terminal 2 and the cell edge may be any one of arbitrary values including a negative value and zero. For example, when the mobile terminal 2 is located in a cell whose distance to the mobile terminal 2 is to be calculated, the distance to the cell edge is a negative value. On the other hand, when the mobile terminal 2 is located outside the cell whose distance to the mobile terminal 2 is to be calculated, the distance to the cell edge is a positive value.

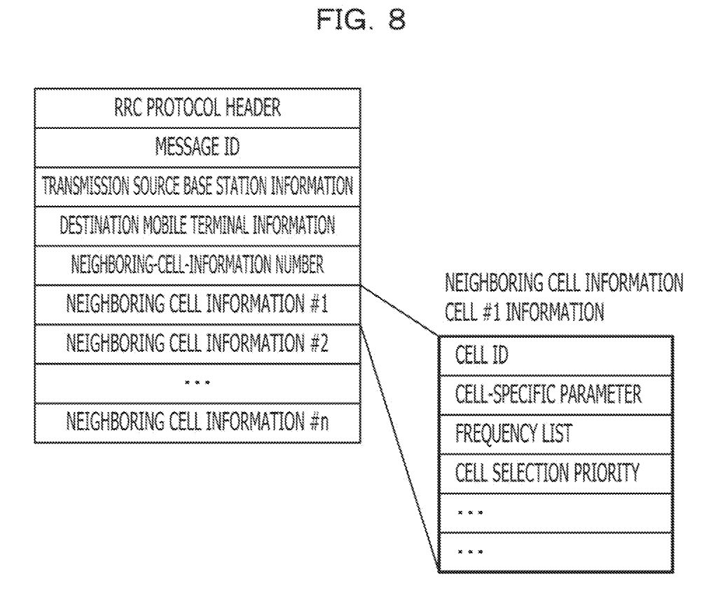

(9) The RRC controller 25 notifies the terminal UE1 of a neighboring cell recorded in the neighboring cell table 32. FIG. 8 is a diagram illustrating an example of a neighboring cell information notification message 61. The neighboring cell information notification message 61 includes an RRC protocol header, a message ID indicating the neighboring cell information notification message 61, and information used for identifying the macrocell base station 10 that is a transmission source and the terminal UE1 that is a destination, in addition to information relating to a neighboring cell. In the example illustrated in FIG. 8, the information relating to a neighboring cell includes the number of neighboring cell information, a cell ID used for specifying each of neighboring cells, a frequency band used for communication performed in the cell, and the like.

Here, when the number of the selected neighboring cells is less than or equal to the maximum neighboring-cell-information number, the RRC controller 25 notifies the mobile terminal 2 of information used for specifying each cell with respect to all neighboring cells. On the other hand, when the number of the selected neighboring cells is greater than the maximum neighboring-cell-information number, the RRC controller 25 preferentially notifies the mobile terminal 2 of a cell, the distance of the mobile terminal 2 to the cell edge of which is short. For example, it is assumed that the maximum neighboring-cell-information number of the mobile terminal 2 to which the identifier “UE1” is attached is three. In this case, the RRC controller 25 transmits to the mobile terminal 2 the neighboring cell information notification message 61 including information used for specifying the cells C2, C3, and C5.

(10) The mobile terminal 2 acquires the information of a neighboring cell, included in the neighboring cell information notification message 61, and replaces the information with the information acquired in Procedure (3). On the basis of the procedure, the terminal UE1 deletes the information of cells other than the neighboring cells of the terminal UE1. Accordingly, here, the mobile terminal 2 to which the identifier “UE1” is attached recognizes the cells C2, C3, and C5 as the neighboring cells.

(11) When the monitoring controller 14 acquires information from the femtocell base station 40 or the like, the monitoring controller 14 can update the cell location database 31 on the basis of the acquired information.

(12) The measurement start request unit 23 requests the terminal UE1 to measure the intensity of reception power from each of the neighboring cells.

(13) The terminal UE1 starts measuring electric power received from each of the neighboring cells. The mobile terminal 2 preliminarily stores the threshold value of the reception power. It is assumed that the terminal UE1 can establish a connection with a base station forming a cell the reception power from which is electric power greater than or equal to the threshold value. The value of the threshold value of the reception power may be arbitrarily set in accordance with implementation. When the reception power from any one of the neighboring cells is weaker than the threshold value, the processing operations performed in Procedures (6) to (11) are repeated, and the terminal UE1 periodically measures the intensity of the reception power from the neighboring cells.

(14) When there is a cell the reception power from which is greater than or equal to the threshold value, the terminal UE1 transmits a measurement result report message, and notifies the macrocell base station 10 of the cell from which electric power greater than or equal to the threshold value is received. For example, the terminal UE1 notifies the macrocell base station 10 that the reception power from each of the cells C2 and C3 is greater than or equal to the threshold value.

(15) On the basis of the measurement result report message transmitted from the mobile terminal 2, the macrocell base station 10 instructs the mobile terminal 2 to perform handover. For example, when the reception power from the cell C3 is stronger than the reception power from the cell C2, the macrocell base station 10 instructs the mobile terminal 2 to be handed over to the cell C3.

(16) On the basis of the handover, a control channel is established between the femtocell base station 40 and the mobile terminal 2. In addition, a control channel between the macrocell base station 10 and the mobile terminal 2 is released.

As described above, the information of a cell, of which the mobile terminal 2 is notified in Procedure (9) or the like, is information relating to the neighboring cells of the mobile terminal 2. Accordingly, the information of a cell installed in a location to which it is difficult to hand over the mobile terminal 2 is not notified to the mobile terminal 2 in Procedure (9). Since the mobile terminal 2 measures the intensity of electric power received from the cell given notice of in Procedure (9), the mobile terminal 2 does not measure the intensity of electric power received from the cell located in a location to which it is difficult to hand over the mobile terminal 2, according to the present embodiment. Accordingly, a processing operation relating to the cell to which it is difficult to hand over the mobile terminal 2 is not performed. Furthermore, according to the restriction of the maximum neighboring-cell-information number, a situation can also be avoided in which a cell that is not a neighboring cell is given notice of and a cell to be intrinsically a measurement target for handover is not notified to a terminal.

In addition, according to the present embodiment, the macrocell base station 10 notifies the mobile terminal 2 of the information of cells the number of which is less than or equal to the maximum neighboring-cell-information number. Accordingly, the information notified to the mobile terminal 2 can also avoid a situation in which a load over the processing capacity of the mobile terminal 2 rests on the mobile terminal 2.

### Second Embodiment

While, in the first embodiment, a case has been described in which any femtocell base station 40 forming a neighboring cell is not put into the resume state, there may also be a case in which the femtocell base station 40 forming one of neighboring cells is put into the resume state. Accordingly, in the second embodiment, a case will be described in which a cell formed by the femtocell base station 40 put into the resume state is included in neighboring cells. In the following description, it is assumed that the mobile terminal 2 to which an identifier “UE2” is attached is handed over from the macrocell base station 10 to the femtocell base station 40a. In addition, it is assumed that base stations configuring the neighboring cells of the UE2 are the femtocell base stations 40a and 40b. Here, it is assumed that any one of the femtocell base stations 40a and 40b has been put into the resume state.

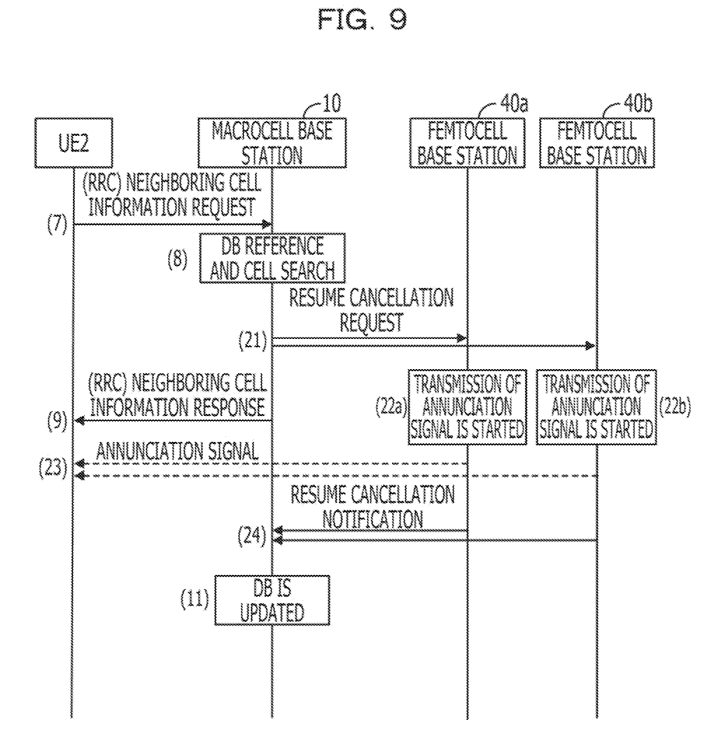

FIG. 9 is a sequence diagram explaining an example of an operation performed when the macrocell base station 10 requests the femtocell base stations 40a and 40b to transmit annunciation signals. FIG. 9 illustrates an example of an operation performed by the femtocell base station 40 and the like while Procedures (8) to (11) described with reference to FIG. 5 are performed. In FIG. 9, an operation to which the same procedure number as that in FIG. 5 is attached is performed in the same way as the procedure described with reference to FIG. 5. When the neighboring cell information request message 60 is transmitted in Procedure (7), the macrocell base station 10 generates the neighboring cell table 32 of the terminal UE2 by referring to the cell location database 31 in Procedure (8). It is assumed that the neighboring cell table 32 includes the cell C2 formed by the femtocell base station 40a and the cell C3 formed by the femtocell base station 40b.

(21) When the neighboring cell table 32 is generated, the annunciation signal transmission request unit 22 requests each of the base stations forming the neighboring cells to transmit an annunciation signal. For example, by transmitting a resume cancellation request message 62 generated in the annunciation signal transmission request unit 22 to the monitoring controller 44 of each of the femtocell base stations 40a and 40b, the monitoring controller 14 can request to transmit an annunciation signal.

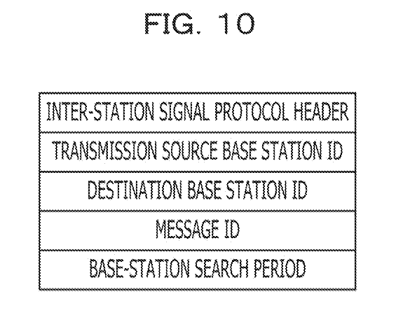

FIG. 10 is a diagram illustrating an example of the resume cancellation request message 62. The resume cancellation request message 62 includes an inter-station signal protocol header, the identifier of each of base stations that are a transmission source and a destination, a message ID, and the base-station search period of the terminal UE2. Here, it is assumed that the macrocell base station 10 and the femtocell base stations 40a and 40b preliminarily store the kind of the control message received through the inter-station line and the message ID thereof with associating the kind of the control message with the message ID.

(22a or 22b) When the resume cancellation request message 62 is received, the monitoring controller 44 notifies the resume controller 45 that the resume cancellation request message 62 is received and of the base-station search period. The resume controller 45 sets the timer for a time period longer than or equal to the base-station search period, and cancels the resume state of the femtocell base station 40 until the timer expires. While the setting value of the timer can be set to an arbitrary time period longer than or equal to the base-station search period, it is assumed, in the following description, that the resume controller 45 sets the timer for a time period obtained by adding a preliminarily set search time period to the base-station search period.

(23) When the resume state is cancelled, electric power is supplied to the call controller 50 in each of the femtocell base stations 40a and 40b. The annunciation signal controller 51 in each of the femtocell base stations 40a and 40b transmits an annunciation signal.

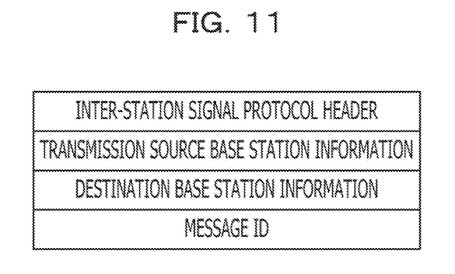

(24) Each of the femtocell base stations 40a and 40b transmits the resume cancellation notification message 63 to the macrocell base station 10. In FIG. 11, an example of the resume cancellation notification message 63 is illustrated. The resume cancellation notification message 63 includes an inter-station signal protocol header, the identifier of each of base stations that are a transmission source and a destination, and a message ID.

The above-mentioned description is an example of a cancel method for the resume state, and the operations of the macrocell base station 10 and the femtocell base station 40 may be changed in accordance with implementation. For example, while, in FIG. 9, the resume controller 45 sets the timer before the transmission of the resume cancellation notification message 63, and starts transmitting the annunciation signal, the setting of the timer and the start of the transmission of the annunciation signal may be after the transmission of the resume cancellation notification message 63.

Every time the macrocell base station 10 receives the neighboring cell information request message 60 from the mobile terminal 2, the macrocell base station 10 transmits the resume cancellation request message 62 to the femtocell base station 40 forming a neighboring cell. Accordingly, in some case, the femtocell base station 40 may newly receive the resume cancellation request message 62 before the timer expires. In this case, the resume controller 45 compares a time elapsing before the timer expires with the base-station search period. When the base-station search period is longer than the time elapsing before the timer expires, the resume controller 45 changes the setting value of the timer to a value corresponding to the sum of the base-station search period and the preliminarily set search time period.

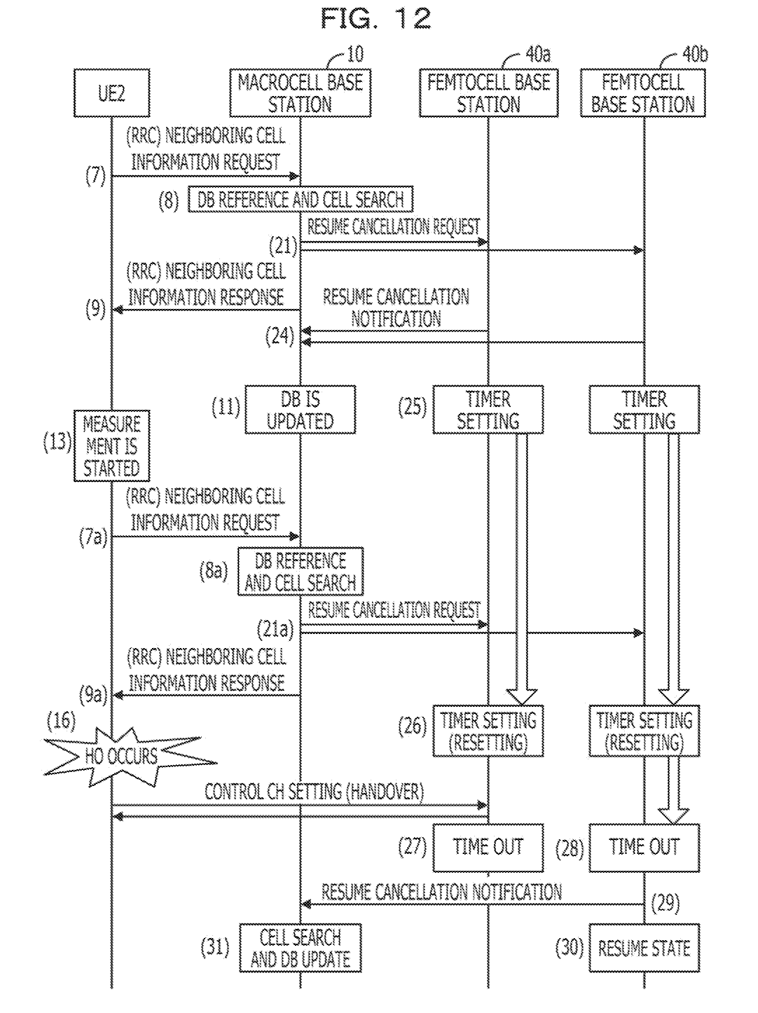

FIG. 12 is a sequence diagram explaining an example of an operation performed when the femtocell base station 40 receives the resume cancellation request message 62 before the time period set in Procedure (24) elapses. In operations illustrated in FIG. 12, Procedures (7) to (13) are substantially the same as those described with reference to FIG. 5, and Procedures (21) to (24) are substantially the same as those described with reference to FIG. 9. In the example in FIG. 12, it is assumed that the setting of the timer and the transmission of an annunciation signal are performed after the resume cancellation notification message 63 is transmitted.

(25) The resume controller 45 in the femtocell base station 40a sets the timer for a value corresponding to the sum of the base-station search period and the search time period, and cancels the setting of a resume state with respect to the femtocell base station 40a until the timer expires. The resume controller 45 in the femtocell base station 40b also cancels the setting of a resume state.

After the timer is set in Procedure (25), the terminal UE2 measures power intensity received from each of neighboring cells (Procedure (13)). In a case in which electric power greater than or equal to the threshold value is not received even if one period of the base-station search period elapses after the search for a base station is started, the terminal UE2 retransmits the neighboring cell information request message 60 to the macrocell base station 10 (Procedure (7a)). When the macrocell base station 10 receives the neighboring cell information request message 60, the macrocell base station 10 generates the neighboring cell table 32 on the basis of the cell location database 31, and transmits the resume cancellation request message 62 to the neighboring cell (Procedures (8a) and (21a)).

(26) The femtocell base station 40a acquires a base-station search period included in the newly received resume cancellation request message 62. Furthermore, the resume controller 45 compares the time elapsing before the timer expires with the base-station search period recorded in the newly received resume cancellation request message 62. When the base-station search period is longer than the time elapsing before the timer expires, the resume controller 45 sets the setting value of the timer to a value corresponding to the sum of the base-station search period and the search time period. The femtocell base station 40b also operates in substantially the same way as the femtocell base station 40a.

It is assumed that, after that, the terminal UE2 receives electric power greater than or equal to the threshold value from the femtocell base station 40a. Subsequently, the mobile terminal 2 transmits a measurement result report to the macrocell base station 10. The terminal UE2 is instructed by the macrocell base station 10 to be handed over to the femtocell base station 40a, and establishes a connection with the femtocell base station 40a.

(27) When the timer expires, the femtocell base station 40a confirms whether there is the mobile terminal 2 connected to the femtocell base station 40a. When the connection between the femtocell base station 40a and the terminal UE2 is established, the operation of the femtocell base station 40a is continued.

(28) When the timer expires, the femtocell base station 40b confirms whether there is the mobile terminal 2 connected to the femtocell base station 40b. When there is the mobile terminal 2 connected to the femtocell base station 40b, the femtocell base station 40b continues the operation thereof.

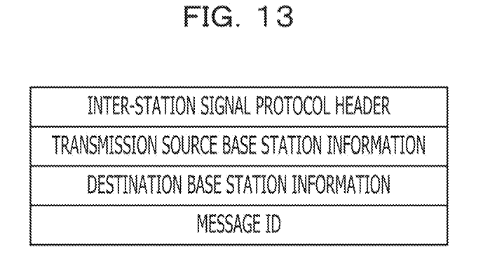

(29) When there is no mobile terminal 2 connected to the femtocell base station 40b, the femtocell base station 40b transmits a resume setting notification message 64 to the macrocell base station 10. An example of the resume setting notification message 64 is illustrated in FIG. 13. The resume setting notification message 64 includes an inter-station signal protocol header, the identifier of each of base stations that are a transmission source and a destination, and a message ID.

(30) After the resume controller 45 in the femtocell base station 40b transmits the resume setting notification message 64 to the macrocell base station 10, the resume controller 45 puts the femtocell base station 40b into a resume state.

(31) When the macrocell base station 10 receives the resume setting notification message 64, the macrocell base station 10 records information indicating that the femtocell base station 40b is in the resume state. In addition, in the same way as in Procedure (11), Procedure (31) is also optional, and may be arbitrarily omitted.

When reception power measurement is not performed under the condition that the femtocell base station 40 is a neighboring cell, and furthermore there is no mobile terminal 2 connected to the femtocell base station 40, the femtocell base station 40 is out of use. In the state in which the femtocell base station 40 is out of use, the femtocell base station 40 can reduce the power consumption thereof by shifting to the resume state. In the present embodiment, before the mobile terminal 2 starts measuring reception power from a neighboring cell, the resume cancellation request message 62 for requesting to transmit an annunciation signal is transmitted from the macrocell base station 10 to the femtocell base station 40 forming a neighboring cell. Accordingly, when the timer has expired, the femtocell base station 40 can determine that reception power measurement is not performed under the condition that the femtocell base station 40 is a neighboring cell. In addition, the femtocell base station 40 has recognized whether there has been the mobile terminal 2 connected to the femtocell base station 40. Accordingly, when reception power measurement is not performed under the condition that the femtocell base station 40 is a neighboring cell, and furthermore there is no mobile terminal 2 connected to the femtocell base station 40, the femtocell base station 40 can shift to the resume state.

According to the present embodiment, by putting the femtocell base station 40 into the resume state until the resume cancellation request message 62 is transmitted, the power consumption of the femtocell base station 40 can be reduced. In addition, since the reception of the resume cancellation request message 62 triggers the femtocell base station 40 to transmit the annunciation signal, the handover or the communication of the mobile terminal 2 is not interrupted even if the femtocell base station 40 is put into the resume state.

Incidentally, since, in some cases, a mobile terminal may be moved during the power-off of the mobile terminal, there is also a possibility that the mobile terminal enters a femtocell during the power-off of the mobile terminal, and the mobile terminal is powered on in the femtocell. Furthermore, there is also a possibility that the femtocell base station 40 forming a femtocell in which the mobile terminal 2 is located is in the resume state. Also in this case, the reception of the resume cancellation request message 62 from the macrocell base station 10 can trigger the femtocell base station 40 to transmit the annunciation signal, the femtocell base station 40 forming the cell in which the mobile terminal 2 is located. Accordingly, also in such a case as described above, the mobile terminal 2 can be handed over to the femtocell base station 40 in accordance with the procedures described in FIG. 10 or FIG. 12, and the communication of the mobile terminal 2 is not interrupted.

As described above, when the femtocell base station 40 is put into the resume state during a time period when the femtocell base station 40 is out of use, and hence a signal such as an annunciation signal or the like is not transmitted, the effect of interference of the femtocell base station 40 on another cell can also be reduced. For example, when the femtocell base station 40 forming the cell C2 is put into the resume state, the effect of interference on another femtocell located around the cell C2, the macrocell C1 overlaid with the C2 and installed, and the like can be reduced.

In addition, since the selection of neighboring cells to be notified to the mobile terminal 2 is performed in substantially the same way as in the first embodiment, the information of neighboring cells notified to the mobile terminal 2 does not include the information of a cell installed in a location to which it is difficult to hand over the mobile terminal 2. Accordingly, also in the second embodiment, the increase of the processing load of the mobile terminal 2 may be prevented that is due to a processing operation relating to a cell to which it is difficult to hand over the mobile terminal 2.

### Third Embodiment

In the third embodiment, the mobile terminal 2 located in a first macrocell can acquire not only the information of a femtocell installed in the first macrocell but also the information of a femtocell installed in a second macrocell.

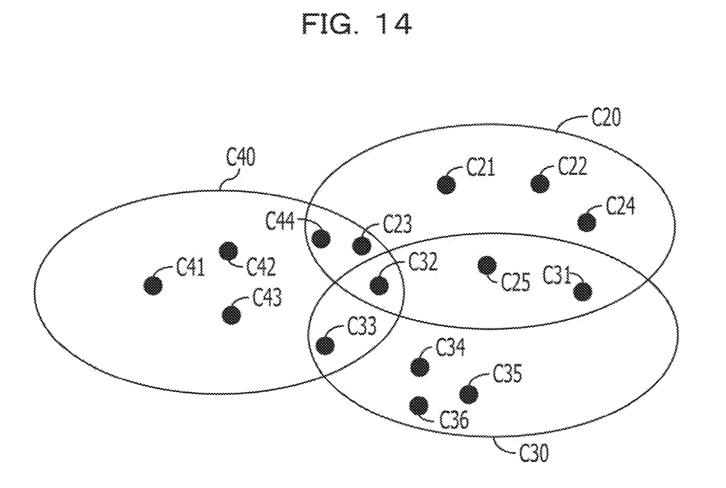

FIG. 14 is a diagram illustrating an example of the arrangement of cells when the third embodiment is applied. In the example illustrated in FIG. 14, it is assumed that femtocells C21 to C25, C31 to C36, and C41 to C44 are formed in three macrocells C20, C30, and C40.

In the following description, in same case, a macrocell that includes a femtocell and holds the cell information database 33 including the information of the femtocell is described as the “parent cell” of the femtocell. For example, it is assumed that the femtocell C21 is formed in the macrocell C20, and a macrocell base station forming the C20 holds the cell information database 33 including information such as a frequency band used for the communication of the C21 and the like. In this case, the macrocell C20 is the parent cell of the femtocell C21.

Furthermore, in the following description, in some cases, a macrocell that includes a femtocell and does not hold the information of the femtocell is described as a “quasi-parent cell”. For example, the femtocell C33 is included in both the macrocell C40 and the macrocell C30. Here, it is assumed that a macrocell base station forming the C40 does not hold information such as a frequency band used for the communication of the C33 and the like. In this case, the macrocell C40 is the quasi-parent cell of the femtocell C33.

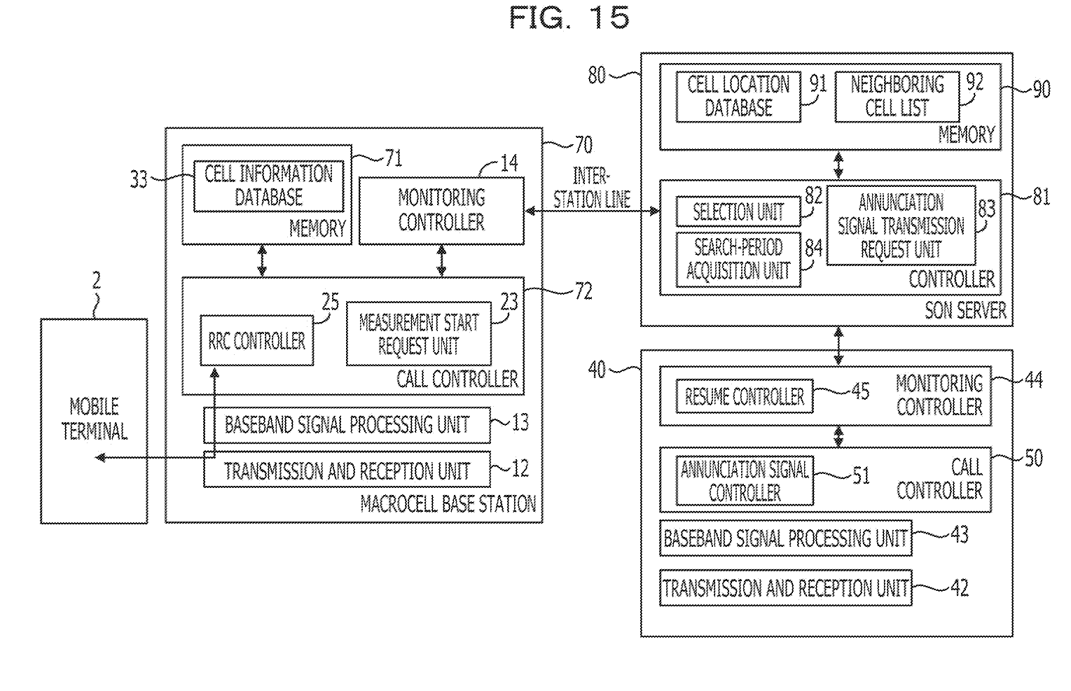

FIG. 15 is a diagram illustrating an example of a system available for the third embodiment. In the third embodiment, a macrocell base station 70 and a Self Organizing Network (SON) server 80 are used. In a macrocell formed by the macrocell base station 70, a femtocell is formed by the femtocell base station 40. The femtocell base station 40 may have substantially the same configuration as that described in the first or second embodiment.

The macrocell base station 70 includes an antenna 11 (not illustrated), a transmission and reception unit 12, a baseband signal processing unit 13, a monitoring controller 14, a memory 71, and a call controller 72. The call controller 72 includes a measurement start request unit 23 and an RRC controller 25. The operations of the antenna 11, the transmission and reception unit 12, the baseband signal processing unit 13, the monitoring controller 14, the measurement start request unit 23, and the RRC controller 25 are substantially the same as those in the first or second embodiment. The memory 71 is arbitrarily used for the processing of the call controller 72, the monitoring controller 14, or the like, and stores data and the like. The memory 71 records the cell information database 33. Information used for communication with a femtocell the parent cell of which is a macrocell formed by the macrocell base station 70 is recorded in the cell information database 33. A CPU (Central Processing Unit), DSP (Digital Signal Processor) or the like provides functions executed by the call controller 72.

The SON server 80 includes a controller 81, a selection unit 82, an annunciation signal transmission request unit 83, a search-period acquisition unit 84, and a memory 90, and the memory 90 includes a cell location database 91 and a neighboring cell list 92. The controller 81 performs the update of the cell location database 91, the control of the SON server 80, and the like. The selection unit 82 generates the neighboring cell list 92 from data included in the cell location database 91. A CPU (Central Processing Unit), DSP (Digital Signal Processor) or the like provides functions executed by the controller 81.

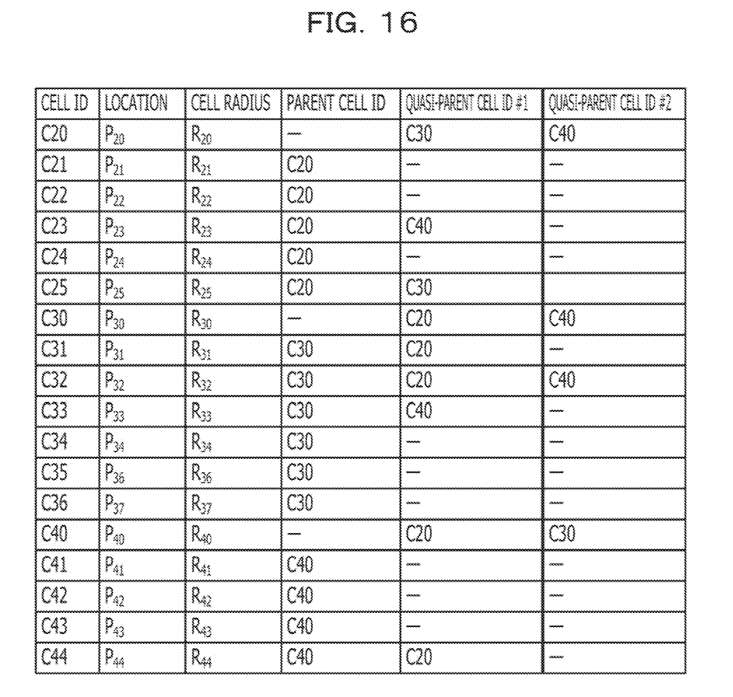

FIG. 16 is a diagram illustrating an example of the cell location database 91 used in the third embodiment. In the example illustrated in FIG. 16, the information of the three macrocells C20, C30, and C40 and femtocells installed therein is recorded in the cell location database 91. The cell location database 91 records therein the identifier of a cell, the location of a cell, a cell radius, a parent cell ID, and a quasi-parent cell ID. Since there is no parent cell with respect to the macrocells, the cell location database 91 records therein no parent cell ID. In the cell location database 91, in order to record locational relationships between a plurality of macrocells, the ID of a macrocell adjacent to another macrocell is recorded in the field of the quasi-parent ID. For example, as illustrated in FIG. 14, the macrocell C20 is adjacent to the two macrocells C30 and C40. Therefore, the cells C30 and C40 are recorded in the field of the quasi-parent ID associated with the cell C20. In addition, FIG. 16 is an example of the cell location database 91, and information elements included in the cell location database 31 may be changed in accordance with implementation. For example, while, in FIG. 16, two quasi-parent cell IDs are recorded, more than two quasi-parent cell IDs may be recorded when there are more than two quasi-parent cells with respect to one femtocell. In addition, in the same way as the cell location database 31 illustrated in FIG. 4, the cell location database 91 may also record the state of a base station and the group of a base station.

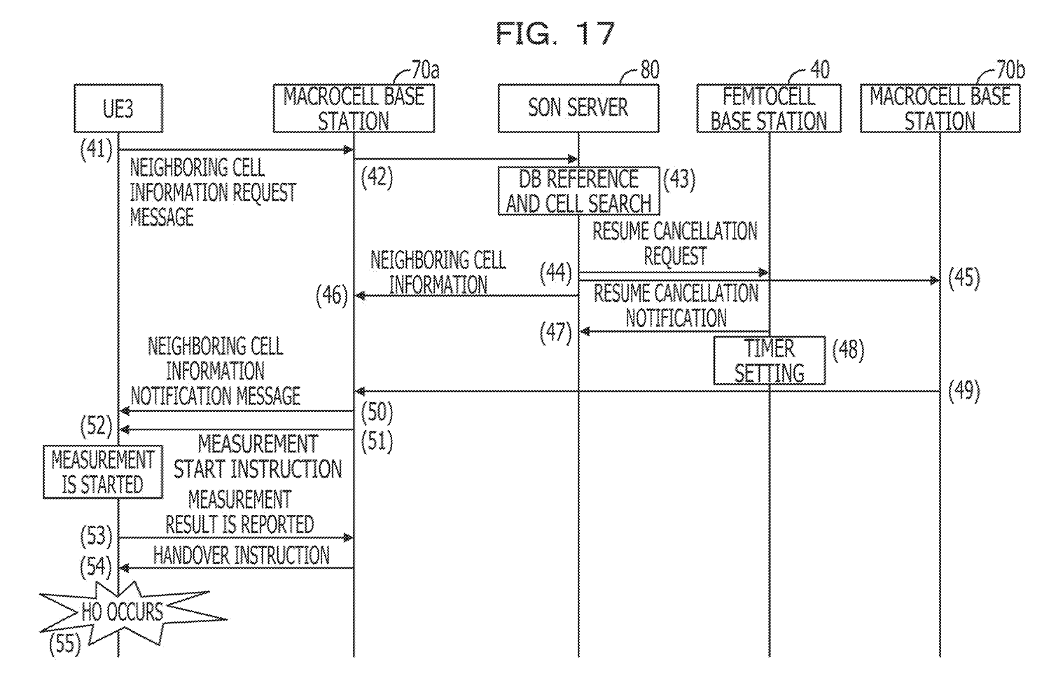

FIG. 17 is a sequence diagram explaining an example of an operation performed in the third embodiment. With reference to FIG. 17, an operation performed for the handover of the mobile terminal 2 to which an identifier “UE3” is attached will be described. In addition, FIG. 17 is an example of a procedure. For example, in some cases, Procedure (49) may be performed before Procedure (47).

(41) The mobile terminal 2 transmits the neighboring cell information request message 60 to the macrocell base station 70. In the following description, as an example, it is assumed that the terminal UE3, connected to a macrocell base station 70a forming the macrocell C40, transmits the neighboring cell information request message 60. In addition, it is assumed that the location of the terminal UE3 is P_{M}. Here, the neighboring cell information request message 60 may have substantially the same configuration as that of the first embodiment.

(42) Using an inter-station line, the macrocell base station 70a transfers the neighboring cell information request message 60 to the SON server 80. Alternatively, the macrocell base station 70a may also transmit to the SON server 80 a message used for giving notice of the location, the base-station search period, the maximum neighboring-cell-information number, and the like of the mobile terminal 2. In any of these cases, the macrocell base station 70 notifies the SON server 80 of an identifier used for identifying a base station that is a transmission source. Here, the macrocell base station 70a notifies the SON server 80 of “C40” as an identifier used for identifying a base station that is a transmission source.

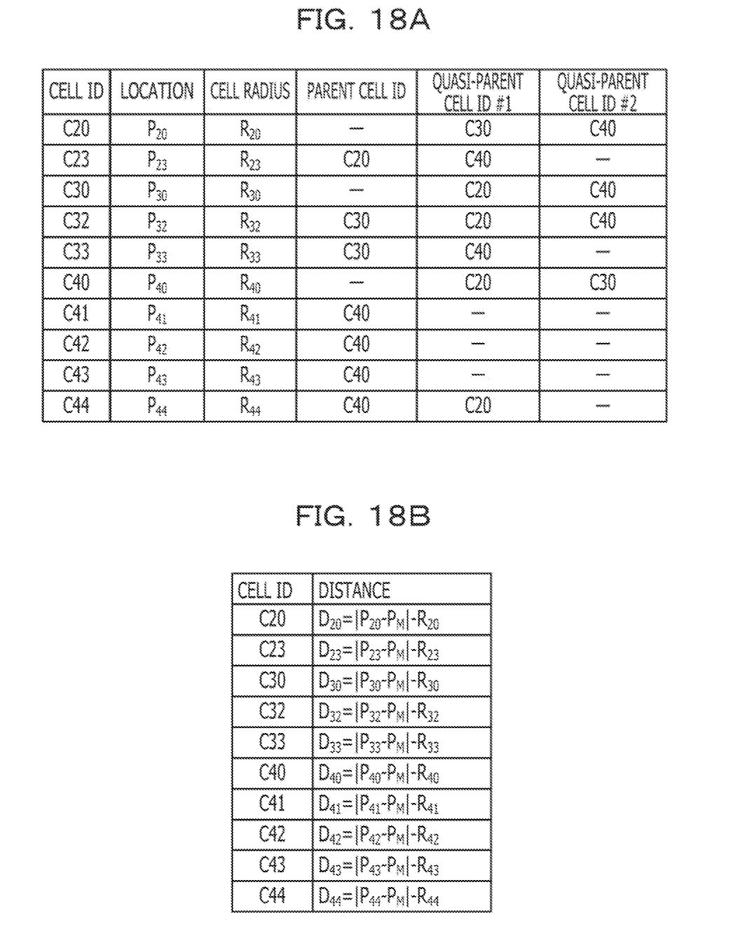

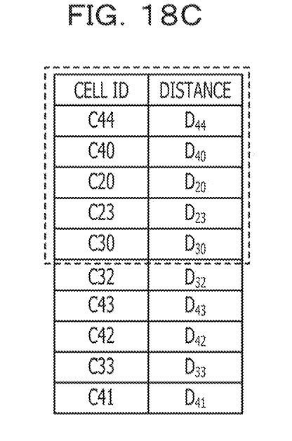

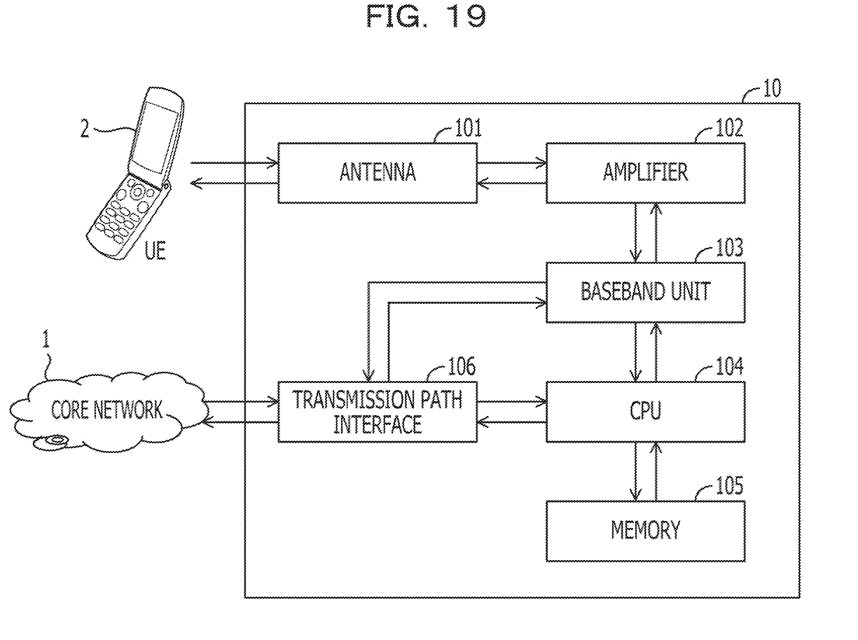

(43) On the basis of information received from the macrocell base station 70a, the selection unit 82 searches the cell location database 91, and generates the neighboring cell list 92. With reference to FIGS. 18A to 18C, the operation of the selection unit 82 performed when the neighboring cell list 92 is generated will be described.

The selection unit 82 determines that the mobile terminal 2 is located in the cell to which the identifier “C40” is attached, and selects a cell the parent cell ID or the quasi-parent cell ID of which includes “C40”, from the cell location database 91. FIG. 18A illustrates an example of a table obtained by selecting the cell the parent cell ID or the quasi-parent cell ID of which includes “C40”.

Next, with respect to each of the selected cells, the selection unit 82 calculates a distance between the mobile terminal 2 and a cell edge. A calculation method for the distance between the mobile terminal 2 and the cell edge is substantially the same as described in the first embodiment. FIG. 18B illustrates the calculation result of the distance between the mobile terminal 2 and the cell edge.

The selection unit 82 sorts the combinations of cell IDs and distances in ascending order of the calculated distance. For example, when the distances between the mobile terminal 2 and the cell edges ascend in the order of D₄₄<D₄₀<D₂₀<D₂₃<D₃₀<D₃₂<D₄₃<D₄₂<D₃₃<D₄₁, the combinations of cell IDs and distances are sorted as illustrated in FIG. 18C. The selection unit 82 selects the data of cells the number of which is less than or equal to the maximum neighboring-cell-information number, from the sorted data, and generates the neighboring cell list 92. For example, the neighboring cell list 92 obtained when the maximum neighboring-cell-information number is 5 is illustrated with a dotted line in FIG. 18C.

(44) The search-period acquisition unit 84 acquires the base-station search period of the mobile terminal 2 from information the macrocell base station 70a has given notice of, and notifies the annunciation signal transmission request unit 83 of the base-station search period. The annunciation signal transmission request unit 83 transmits the resume cancellation request message 62 to each of base stations forming femtocells included in the neighboring cell list 92, through the inter-station line. While, in FIG. 17, in order to improve visualization, only one femtocell base station 40 is described, the number of the femtocell base stations 40 to which the resume cancellation request message 62 is transmitted is the same as the number of femtocells included in the neighboring cell list 92. For example, when the neighboring cell list 92 illustrated in FIG. 18C is generated, the annunciation signal transmission request unit 83 transmits the resume cancellation request message 62 to the femtocell base station 40c forming the cell C44 and the femtocell base station 40d forming the cell C23.

(45) On the other hand, the controller 81 notifies the macrocell base station 70 included in the neighboring cell list 92 of the identifier of a femtocell included in the neighboring cell list 92, from among femtocells the macrocell of which is the parent cell thereof. Furthermore, the controller 81 also gives notice of a cell to which the mobile terminal 2 that has output the neighboring cell information request message 60 is connected. For example, the controller 81 notifies the macrocell base station 70b forming the macrocell C20 that the C23 is included in the neighboring cell list 92 and the mobile terminal 2 to which the identifier UE3 is attached is connected to the macrocell C40. In addition, it is assumed that the notification in Procedure (45) is also performed as many times as the number of the macrocell base stations 70 forming macrocells included in the neighboring cell list 92.

(46) The SON server 80 transmits the neighboring cell list 92 to the macrocell base station 70a.

(47) When receiving the resume cancellation request message 62, the femtocell base station 40 cancels the resume state, and transmits the resume cancellation notification message 63 to the SON server 80.

(48) The femtocell base station 40 sets a timer for a time period longer than the base-station search period given notice of by the resume cancellation request message 62.

(49) The macrocell base station 70b that has received the notification in Procedure (45) extracts the cell information of a femtocell given notice of, from the cell information database 33. Next, the macrocell base station 70b notifies the macrocell base station 70a to which the mobile terminal 2 is connected of the information of the extracted cell. For example, the macrocell forming the cell C20 notifies the macrocell base station 70a of information, recorded in the cell information database 33 with respect to the femtocell C23, with associating the information with a cell identifier. In addition, information used when the cell C20 and the mobile terminal 2 communicate with each other is also notified to the macrocell base station 70a, with being associating with a cell identifier. In accordance with the procedure, information such as a frequency, priority, and the like, used in a femtocell the parent cell of which is another macrocell base station 70 different from the macrocell base station 70a, are notified to the macrocell base station 70a (C40).

(50) The macrocell base station 70a notifies the terminal UE3 of the neighboring cell list 92 and information such as an identifier, a used frequency, priority, and the like relating to each of cells included in the neighboring cell list 92.

The procedures in (51) to (55) are substantially the same as those in Procedures (12) to (16) described in the first embodiment.

Using the third embodiment, the mobile terminal 2 can be handed over to a femtocell installed in a macrocell different from the macrocell to which the mobile terminal 2 is connected. In addition, at the time of the handover of the mobile terminal 2, in the same way as in the first embodiment, the information of a cell to which it is difficult to hand over the mobile terminal 2 is not notified to the mobile terminal 2. In addition, the resume cancellation request message 62 is notified to a femtocell that has become a neighboring cell. Therefore, as described in the second embodiment, even if a femtocell is put into a resume state when the femtocell is out of use, the handover is not interrupted.

<Hardware Configuration>

FIG. 19 is a diagram illustrating an example of the hardware configuration of the macrocell base station 10. The macrocell base station 10 includes an antenna 101, an amplifier 102, a baseband unit 103, a Central Processing Unit (CPU) 104, a memory 105, and a transmission path interface 106. The macrocell base station 10 communicates with the mobile terminal 2 through the antenna 101. In addition, the antenna 101 and the amplifier 102 operate as the antenna 11 and the transmission and reception unit 12. The baseband unit 103 operates as the baseband signal processing unit 13. By executing a program stored in the memory 105, the CPU 104 operates as the call controllers 20 and 72. The memory 105 corresponds to the memories 30 and 71, and stores therein a program, the cell location database 31, the neighboring cell table 32, the cell information database 33, and the like. The macrocell base station 10 establishes communication with the core network 1 through the transmission path interface 106, and establishes communication through the inter-station line. Accordingly, the CPU 104 and the transmission path interface 106 realize the operation of the monitoring controller 14.

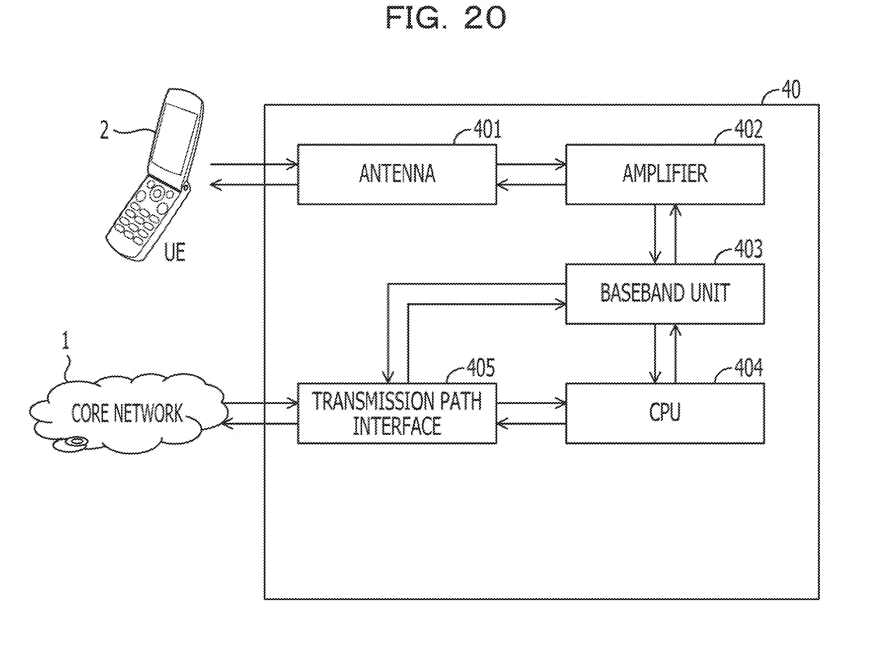

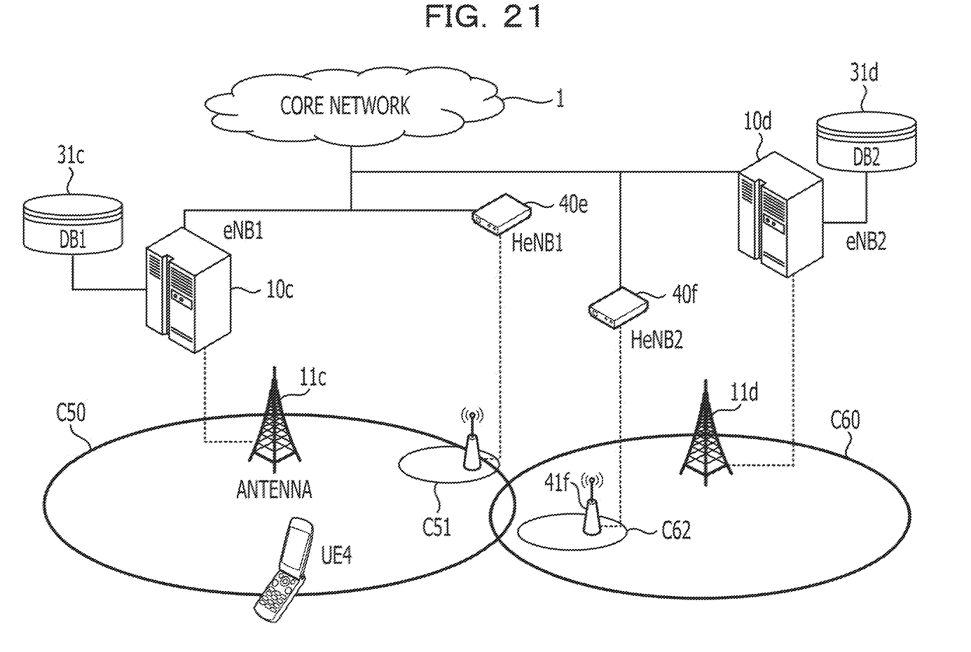

FIG. 20 is a diagram illustrating an example of the hardware configuration of the femtocell base station 40. The femtocell base station 40 includes an antenna 401, an amplifier 402, a baseband unit 403, a CPU 404, and a transmission path interface 405. In addition, FIG. 20 is an example of the configuration of the femtocell base station 40. In addition, in some case, the femtocell base station 40 may include a memory (not illustrated), for example, and the configuration of the femtocell base station 40 may be changed. The femtocell base station 40 establishes communication with the mobile terminal 2 through the antenna 401. In addition, the femtocell base station 40 establishes communication with the core network 1 through the transmission path interface 405, and establishes communication through the inter-station line. Furthermore, the antenna 401 and the amplifier 402 operate as the antenna 41 and the transmission and reception unit 42. The baseband unit 403 operates as the baseband signal processing unit 43. By executing a program read into the femtocell base station 40, the CPU 404 operates as the call controller 50. Furthermore, the CPU 404 and the transmission path interface 405 realize the operation of the monitoring controller 44.

<Other>

In addition, the embodiments are not limited to the examples described above, and various modifications may be made to the embodiments. Examples of the modifications will be described hereinafter.

The generation of the neighboring cell table 32 described in Procedure (8) in FIG. 5 is an example, and the neighboring cell table 32 may be generated using another method. For example, with respect to each of femtocells included in the cell location database 31, the selection unit 21 may also select a neighboring cell by calculating a distance between the mobile terminal 2 and a cell edge. In this case, the selection unit 21 may preferentially include a femtocell whose distance between the mobile terminal 2 and the cell edge thereof is short in the neighboring cell table 32. Furthermore, the number of cells the information of which is recorded in the neighboring cell table 32 may be set to the same as the maximum neighboring-cell-information number. For example, in the cell location database 31 illustrated in FIG. 4, with respect to each of the cells C2 to C12, a distance between the terminal UE1 and a cell edge is calculated. When the maximum neighboring-cell-information number of the terminal UE1 is 3, information relating to the three cells C2, C3, and C5 is recorded in the neighboring cell table 32. In addition, in the same way as in the first embodiment, in the second embodiment, the neighboring cell table 32 may also be generated using the same method.

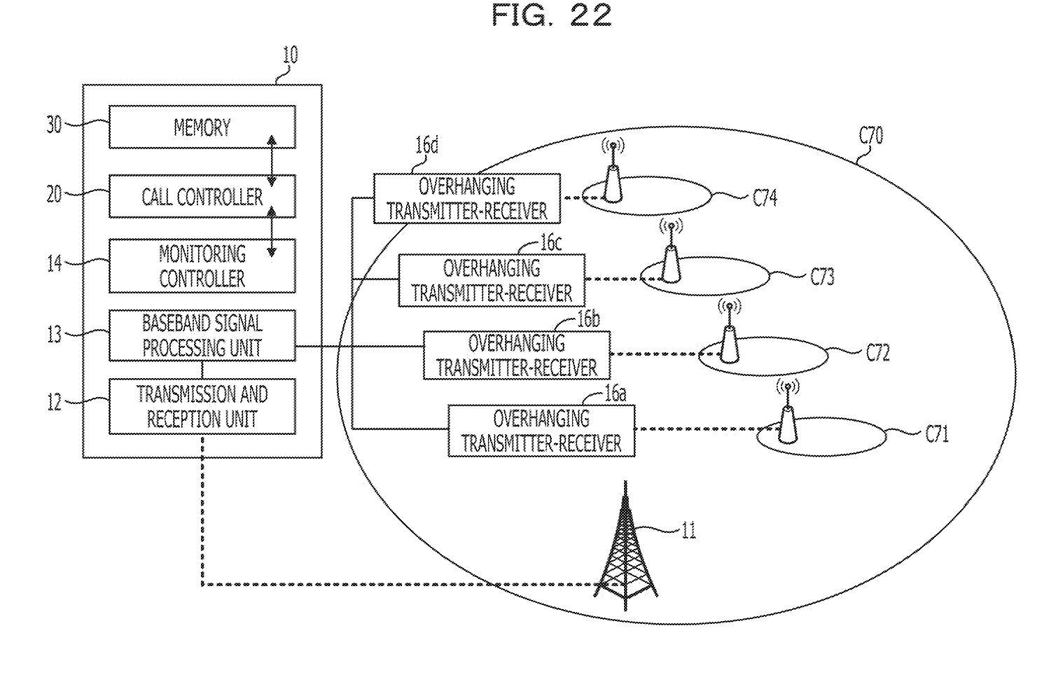

FIG. 21 is a diagram illustrating an example of a system in which a plurality of macrocell base stations 10 exchange the information of a femtocell in a macrocell with one another. The mobile terminal 2 (UE4) connected to a macrocell base station 10c transmits the neighboring cell information request message 60 to the macrocell base station 10c. The macrocell base station 10c generates a neighboring cell table 32c of the UE4 by referring to a cell location database 31c.

Furthermore, the macrocell base station 10c notifies a macrocell base station 10d of the location of the mobile terminal 2, and requests the information of a femtocell located near the mobile terminal 2. The macrocell base station 10d generates a neighboring cell table 32d by referring to a cell location database 31d, and transmits the neighboring cell table 32d to the macrocell base station 10c.

The macrocell base station 10c notifies the mobile terminal 2 of the data of cells the number of which is less than or equal to the maximum neighboring-cell-information number, from among femtocells recorded in the cell location databases 31c and 31d. At this time, with respect to the femtocells recorded in the cell location databases 31c and 31d, the macrocell base station 10c individually compares the distances thereof from the mobile terminal 2 with one another, and preferentially notifies the mobile terminal 2 of a femtocell located near the mobile terminal 2. For example, in the example in FIG. 21, cells C51 and C62 are notified to the mobile terminal 2 that is the UE4. Accordingly, also in the present embodiment, in the same way as in the third embodiment, the handover destination of the UE2 may be not only the cell C51 but also the C62.

FIG. 22 illustrates an example of a system in which an overhanging transmitter-receiver is used with no femtocell being used. In a commercial building or the like, in some cases, a femtocell is not used as a small base station to be installed in each of shops in the building, and a small overhanging transmitter-receiver 16 (16a to 16d) is used. The transmission and reception unit 12 in the macrocell base station 10 is divided into a plurality of portions, and these portions as other devices different from the macrocell base station 10 are individually installed outside the macrocell base station 10, thereby realizing the overhanging transmitter-receiver 16. Each of the overhanging transmitter-receivers 16a to 16d is connected to the macrocell base station 10 using an optical fiber or the like. Here, the number of the overhanging transmitter-receiver 16 may be set to the number of cells the macrocell base station 10 manages. The macrocell base station 10 confirms whether each overhanging transmitter-receiver 16 communicates with the mobile terminal 2. When one overhanging transmitter-receiver 16 does not communicate with the mobile terminal 2, the monitoring controller 14 puts the overhanging transmitter-receiver 16 into a resume state. When the mobile terminal 2 connected to the macrocell base station 10 is located near the overhanging transmitter-receiver 16 put into the resume state, the macrocell base station 10 cancels the setting of the resume state of the overhanging transmitter-receiver 16.

In the third embodiment, the SON server 80 may also hold the cell information database 33. In this case, the SON server 80 has acquired the cell information database 33 from each of the macrocell base stations 10 connected to the SON server 80. When the SON server 80 specifies the femtocell base station 40 forming the neighboring cell of one mobile terminal 2, the SON server 80 notifies the macrocell base station 10 to which the mobile terminal 2 is connected of information such as the frequency band of the femtocell base station 40 or the like.

In addition, as illustrated in FIG. 4, as an optional extra, the cell location database 31 may also have a function of recording the ID of a group including a cell formed by a base station, or the like. When cells are divided into a plurality of groups, the communication of the mobile terminal 2 may be restricted in response to the group ID by allowing handover to be performed between cells the group IDs of which are coincident with one another, for example. For example, it is assumed that the neighboring cell table 32 illustrated in FIG. 7 is obtained with respect to the terminal UE1 and the group ID of the terminal UE1 is “2000232”. In this case, the macrocell base station 10 may notify the terminal UE1 of four cells C2 to C5. On the other hand, when the group ID of the terminal UE1 is “2000322”, the macrocell base station 10 notifies the terminal UE1 of the cells C2 and C5.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

1. A base-station device that forms a first cell in a wireless communication system in which a plurality of second cells are included in the first cell, the base-station device comprising:
a transmission/reception unit to receive control information including information used to specify the location of a mobile terminal from the mobile terminal located in the first cell;
a location information storage unit to store location information indicating the location of each of the plural second cells; and
a processor to select, based on a result obtained by comparing the location of the mobile terminal with the location information, a neighboring cell that can be a destination to which the mobile terminal is handed over from the first cell, from among the plural second cells;
wherein the transmission/reception unit transmits to the mobile terminal a neighboring cell notification message giving notice of the selected neighboring cell.

2. The base-station device according to claim 1, wherein the processor requests each base station forming the selected neighboring cell to transmit an annunciation signal, requests the mobile terminal to start measuring the intensity of reception power the mobile terminal receives from each of the selected neighboring cells, and requests the mobile terminal to start measuring after each base station forming the selected neighboring cell is requested to transmit the annunciation signal.

3. The base-station device according to claim 2, wherein the processor acquires a base-station search period in which the mobile terminal searches for a base station to be a handover destination, and requests each base station forming the selected neighboring cell to transmit the annunciation signal for a time period longer than or equal to the base-station search period.

4. A base-station device that forms one of a plurality of second cells in a wireless communication system in which the plural second cells are included in a first cell, the base-station device comprising:
a processor configured to transmit an annunciation signal for an annunciation signal transmission time period longer than a base-station search period when a control message is received from a base-station device forming the first cell, the control message notifying that a base station can be a handover destination of a mobile terminal located in the first cell and giving notice of the base-station search period in which the mobile terminal searches for a base station to be a handover destination; and
a transmission and reception unit configured to transmit and receive data to and from a mobile terminal a connection with which is established using the annunciation signal, wherein
the annunciation signal controller halts the transmission of the annunciation signal when there is no mobile terminal that establishes a connection using an annunciation signal during the annunciation signal transmission time period.

5. A handover method comprising:
receiving, by a first base station, which forms a first cell, control information including information used to specify the location of a mobile terminal from the mobile terminal located in the first cell;
acquiring, by the first base station, location information indicating the location of each of a plurality of second cells included in the first cell;
selecting, by the first base station, based on a result obtained by comparing the location information with the location of the mobile terminal, neighboring cells that can be a destination to which the mobile terminal is handed over from the first cell, from among the plural second cells; and
notifying, by the first base station, the mobile terminal of the selected neighboring cells; and
handing over, the mobile terminal, from the first cell to a second base station forming one of the selected neighboring cells.

6. The handover method according to claim 5, further comprising:
acquiring, by the first base station, locations of a plurality of fourth cells included in a third cell adjacent to the first cell, in addition to the location information;
selecting the neighboring cells from the plural second and fourth cells based on a result obtained by comparing the location of the mobile terminal with the location information and locations of the plural fourth cells;
notifying, by the first base station, the mobile terminal of the selected neighboring cells; and
handing over, the mobile terminal, to a base station forming one of the selected neighboring cells.
